(19) United States
(12) Patent Application Publication
(10) Pub. No.: US 2010/0122070 A1
(43) Pub. Date: May 13, 2010

(54) Combined associative and distributed arithmetics for multiple inner products

(75) Inventors: David Guevorkian, Tampere (FI); Timo Yli-Pietila, Tampere (FI); Petri Liuha, Tampere (FI)

Correspondence Address: HARRINGTON & SMITH, 4 RESEARCH DRIVE, Suite 202, SHELTON, CT, 06484-6212, US

(73) Assignee: Nokia Corporation

(21) Appl. No.: 12/291,322

(22) Filed: Nov. 7, 2008

(51) Int. Cl. G06F 9/308

(52) U.S. Cl. 712/222; 712/E09.019

(57) ABSTRACT

Subvector slices x(i,r,s) of a first vector x(i) are stored (e.g., in a CAM array) in a bit-parallel word-serial manner. For each of the stored subvector slices and in parallel on bits of said each subvector slice, an operation is executed that outputs a pre-calculated inner product result of the said bits and a second vector a. If the subvector slices x(i,r,s) of the first vector x(i) are initially stored in a bit-serial word-serial manner, there is a transform to store them in the bit-parallel word serial manner by copying relevant bits of each of the subvector slices from a 0^{th} column of a content-addressable memory array to elements of a tags register and, for each k^{th} iteration, shifting bits in the elements of the tags register by m positions and copying the shifted bits to a column of the CAM array. An associative processor outputs the pre-calculated inner product result in a distributed arithmetic manner.

### TECHNICAL FIELD

The exemplary and non-limiting embodiments of this invention relate generally to wireless communication systems, methods, devices and computer programs and, more specifically, relate to parallel computation methods and apparatus for implementing same, which are seen to be particularly advantageous for computations in the wireless communications arts.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section. Whereas both associative computing and distributed arithmetics are summarized in this background description, they are described as independent computational techniques and to the inventors' knowledge it is not known in the art to combine them.

The relevant field of these teachings is massively parallel computation methods. For example, systems supporting a single modem radio standard typically include hardware (HW) accelerators for implementing these types of operations. However, a software defined radio (SDR) system implies support for a large set of radio standards to be implemented on a shared flexible, programmable platform. Taking into account the demand for very high computational power, only highly parallel processors are feasible. Fortunately, most of the computation demanding algorithms in radio standards are potentially parallelizable at a very high level. For example, the digital video broadcast for handheld devices (DVB-H) standard requires implementation of N-point fast Fourier transform (FFT) of either of sizes N=1K, N=2K or N=8K (where K=1024). Implementation of an N-point FFT could be parallelized in a traditional single-instruction stream/multiple-data stream (SIMD) fashion wherein N/2 butterfly operations could be implemented in parallel. Each butterfly is, actually, a product of a 2×2 complex matrix with a 2×1 vector, that is, each butterfly represents four inner products. Therefore, an N-point FFT could potentially be parallelized at the level, where 2N inner products are computed in parallel. Unfortunately, existing SIMD processors offer only parallelism supporting implementation of at most 32 inner products in parallel, and a much higher level of parallelism from traditional SIMD processors is not seen to be likely in the near future.

Another, even more important set of algorithms involved in all radio standards are finite impulse response (FIR) filters of various sizes. In such algorithms, inner products are computed between of a vector of filter coefficients with very large number of vectors formed as the contents of a window that slides across a very long input signal. The length of the vectors are typically in the range between tens and hundreds, but the length of the input signal and therefore the number of inner products to be computed is typically in the range of thousands or tens of thousands. For example, in the front-end of the DVB-H standard, in the 8K mode the number of samples associated with one orthogonal frequency division multiplex (OFDM) symbol is 31.5K. With a proper buffering technique all the inner products could have theoretically been implemented in parallel provided that a processor supporting such a vast parallelism is available.

These are but two examples. With the development of the technology newer applications emerge which from one side demand even higher computational power, and from the other side allow even higher levels of parallelism. At the moment the only processor architecture that appears feasible to support such a vast level of parallelism appears to be associative processor array technology. However, not many of the computation algorithms were yet developed for such processors.

Associative computing (ASC) is a principle used in content-addressable memory based associative processors (ASPs) for massively parallel computations. ASPs are powerful tools to implement massively parallel data processing. Their operation is, in essence based on a look-up table approach. In this approach, input data is first compared with all possible values that these data may potentially take. If these input data is the same as the value to which it is currently compared, the correct pre-calculated output value is written in the corresponding memory field. Further background with regard to associative computing maybe seen, for example, at U.S. Pat. No. 6,195,738 (entitled COMBINED ASSOCIATIVE PROCESSOR AND RANDOM ACCESS MEMORY ARCHITECTURE, issued Feb. 27, 2001), U.S. Pat. No. 6,405,281 (entitled INPUT/OUTPUT METHODS FOR ASSOCIATIVE PROCESSOR, issued Jun. 11, 2002), U.S. Pat. No. 6,711,665 (entitled ASSOCIATIVE PROCESSOR, issued Mar. 23, 2004), and EP Patent Application publication no. EP1713082 A1 (entitled BIT-PARALLEL/BIT-SERIAL COMPOUND CONTENT-ADDRESSABLE (ASSOCIATIVE) MEMORY DEVICES, published Oct. 18, 2001). The associative computing principle is essentially different from conventional functional unit (adder, multiplier, etc.) based methods of implementing arithmetic operations and expressions.

The ASC principle is illustrated at FIGS. 1 and 2, of which FIG. 2 herein is reproduced from FIG. 2 of U.S. Pat. No. 6,405,281 noted above. The central component of the associative processor 100 is one or more arrays (two shown at FIG. 2) 112a, 112b of content-addressable memory (CAM) cells 114a, 114b. CAM-cells are not only capable of storing information (bits) but are also capable of comparing the stored information with an external bit communicated to the cell by a special line (see EP Patent Application publication no. EP 1713082 A1 for details of this feature). The obtained comparison result (1 if matched and 0 if not matched) is put onto a special output line. Each CAM array 112a, 112b is arranged to have associative words 116a′ in rows 116a, 116b and bit slices 118a′ in columns 118a, 118b. The associative words 116a′ may be word-organized bit-parallel, bit-serial or compound. Typical CAM array sizes are 96 to 128 bits wide (number of columns orbit slices) and 2048 to 8192 bits long (number of rows or associative words), though even much longer (up to 65536 bits) Cam arrays have been reported by Aspex Semiconductors Ltd. of Buckinghamshire, United Kingdom.

The ASP 100 of FIGS. 1-2 includes also a logic block consisting of one or more tags registers 120a/b each of the length equal to the number of rows 116a/b in CAM arrays 112a, 112b. Each tags register cell 122a/b contains one bit (0 or 1) and is associated with an associative word 116a′ within one (in the classical case at U.S. Pat. No. 6,195,738) or several CAM arrays (as seen at U.S. Pat. Nos. 6,405,281 and 6,711,665). Tag register cells 122a/b are used for enabling/masking corresponding associative words 116a′ in the rows 116a/b of the CAM arrays 112a/b. When the value of a tags register cell 122a/b is set to 0, then the corresponding CAM row 116a/b (associative word 116a′) is masked meaning that all the cells 114a/b of that row 116a/b are inactive. On the other hand, during the processing, the tags register cell 122a/b may be modified depending on the contents of the associated CAM row 116a/b. There is, therefore, bidirectional communication between CAM array cells 114a/b and associated tags register cells 122a/b. Communication (enabling/masking) from a tags register cell 122a/b to the associated CAM row 116a/b is executed by 1-bit “write enable” signal via “word enable” lines 132a/b and communication from the CAM cells 114a/b to associated tags register cells 122a/b is executed by 1-bit “match signal” via “match result” line 134a/b. The “write enable” signal may be formed according to the value of the bit inside the corresponding tags register cell 122a/b or may be set forth to be 1 for all CAM rows 116a/b. In the latter case all the rows become active irrelevant of the content of the tags register 120a/b. A tags register 120a/b may be shifted (circularly or linearly) by a specified position of bits up or down. This feature is used for communication between CAM rows 116a/b.

In addition, an ASP 100 includes a mask register 124, and a pattern register 128. Both registers are of the length equal to the total number of columns 118a/b in all CAM arrays 112a/b. Cells 126 of the mask register 124 are associated with CAM bit slices 118a′ and are solely used for enabling/masking the corresponding slices. Also the pattern register cells 130 are associated with the CAM bit slices 118a′ so that each cell 130 of the pattern register 128 may be compared with the content of all the bits within the associated CAM bit slice 118a′ in parallel, as well as each bit of the pattern register 128 can in parallel be written to all those bits of that slice 118a′, which are enabled by corresponding bits of the tags register. The content of the pattern register 128 as well as the content of the mask register 130 cannot be modified by the content of the CAM array 112a/b. They are specified by the program operating the associative processor 100.

In ASC, all the arithmetic operations and expressions are implemented based on two elementary operations: “Compare” and “Write”. For both operations, the set of CAM cells 114a/b that participate in the operations are specified by the mask register 124 and by the tags register 120a/b: all and only those cells, for which associated mask bit 126 and associated tags register bit 122a/b are both 1's, will participate in the operation. During one cycle of a compare operation, each activated CAM row 116a/b (enabled by tags register 120a/b) generates a 1 or 0 value to the bit in the associated tags register cell 122a/b depending on whether its content is equal or not equal to the content of the pattern register 128 in all activated bit slices 118a′ (which are enabled by the mask register 124). During one cycle of a write operation, the content of the pattern register 128 in all activated bit slices 118a′ is written in parallel into each of the activated CAM rows 116a/b. Note that each arithmetical operation and even larger expressions may in this way be implemented. Moreover, many of them may be implemented in parallel.

For example, in order to pairwise add N pairs of m-bit integers (N being less than or equal to the number of CAM rows), the following algorithm may be used. Assume the corresponding pairs are written in CAM memory, one pair in a row manner and occupy bits 0 to 2m−1. Also assume that outputs (the pairwise sums) must be written in the same rows as the corresponding input pairs but in the bit slices 2m through 3m. One possible algorithm that pairwise adds all the N pairs in parallel could be as follows. The algorithm executes 2^{2m} steps each step consisting of two operations. The first operation in each of the steps i, i=0, . . . , 2^{2m}−1, is the compare operation over all the CAM rows. During this operation a next possible 2m -bit input i (say [a(i)b(i)], where a(i) denotes m bits of the first operand and b(i) denotes m bits of the second operand) is written in the bits 0 to 2m−1 of the pattern register. This input is compared simultaneously, in one machine cycle, with bits 0 to 2m−1 of each activated associative word. As a result, tags register bits that are associated with those rows that happen to contain the [a(i)b(i)] will become equal to 1, and all the other tags register bits will become equal to 0. hi the second operation of that step, the correct output a(i)+b(i) is written into a designated for outputs field (bits 2m through 3m) of the pattern register and write operation is executed in parallel for all the enabled CAM rows. As a result, the correct sum a(i)+b(i) will be written into bits 2m through 3m of that associative words, for which the tag register cell was set to 1 (that is for which it was identified in the first operation of that step, that they contain the pair [a(i)b(i)] as input). After all the 2^{2m} possible inputs were tested, each associative word will contain the correct result for the input pair written in it in the beginning. The whole computation thus will occupy 2^{2m+1} machine cycles.

The algorithm in the above example is only for illustrative purposes. In a sophisticated algorithm, m-bit additions could possibly be reduced to a set of smaller bit-width additions. Breaking the bit-width up to a single bit-slice will lead to an algorithm where m bit-slices are added in m iterations wherein at each iteration three 1-bit numbers are added (two inputs and one carry-in signal). This way, the number of machine cycles to implement m-bit additions may be estimated as 8 m.

In an even more efficient implementation, this number might still be further reduced. For example, according to NeoMagic Corporation of Santa Clara, Calif., USA, the number of cycles to implement 8-bit additions may be as low as 25 machine cycles per addition. It is also known from NeoMagic Corp. that 12-bit multiplications may be implemented in 200 cycles. It is noted that the number of cycles is independent of the number of pairs for which identical operation is implemented. Thus, up to 8K or even 64K 8-bit additions (or 12-bit multiplications) may be implemented in only 25 (or 200) machine cycles. Even though every single operation is very inefficient, the theoretical possibility to implement many of them in parallel makes the approach extremely efficient.

At least some of the advantages of the associative computing method are as follows:
very high level of parallelism of up to 65536 operations in parallel (e.g., in an Aspex Semiconductors device);
universality, meaning any general-purpose processor operation may be supported;
flexible bit-width;
there are techniques developed for very high-speed data transfers between ASPs and external memories (see U.S. Pat. Nos. 6,195,738, 6,405,281 and 6,711,665), which become important in applications such as SDR where frequent task switches are required;
Aspex Semiconductors and NeoMagic claim also their ASPs are power efficient per operation.

These advantages are offset somewhat by at least the following drawbacks:
high degree of parallelism is not always possible to utilize;
ASC implies totally new programming models and skills;
possible bottlenecks in I/O and data representations in the memory.

Distributed arithmetic's (DA), which is also based on a look-up table approach, is a very efficient way to implement inner vector product operation, differently from the ASP approach. DA is the basic operation in many applications, such as digital signal and image processing, communications, etc. One advantage of DA is its ability to provide accelerated computation of inner products of a vector a=[a₀, . . . , a_{N-1}] with fixed known coefficients aₖ, k=0, . . . , N−1, with a large number of input vectors x=[x₀, . . . , x_{N-1}]^{T}, y=[y₀, . . . , y_{N-1}]^{T}, z=₀, . . . , z_{N-1}]^{T}, etc.

In distribute arithmetic's, computation of an inner product

$$X = a \cdot x = {\sum }_{k = 0}^{N - 1} {a}_{k} {x}_{k} \qquad ( 1 )$$

is reduced to the weighted sum of inner products of the vector a=[a₀, . . . , a_{N-1}] with m binary vectors each being one bit-slice of the vector x=[x₀, . . . , x_{N-1}]^{T}. Let the two's complement binary representation of xₖ, k=0, . . . , N−1, be xₖ=x_{k,m-1}, . . . , k_{k,1}, x_{k,0}. Then

$${x}_{k} = {\sum }_{j = 0}^{m - 1} {x}_{k , j} {2}^{j}$$

and the innerproduct of equation (1) can be rewritten as

$$X = a \cdot x = {\sum }_{k = 0}^{N - 1} {a}_{k} {x}_{k} = {\sum }_{k = 0}^{N - 1} {a}_{k} {\sum }_{j = 0}^{m - 1} {x}_{k , j} {2}^{j} = {\sum }_{j = 0}^{m - 1} {2}^{j} \{ {\sum }_{k = 0}^{N - 1} {x}_{k , j} {a}_{k} \} \qquad ( 2 )$$

Each sum in brace of equation (2) is basically an inner product of the vector a with a binary vector being a bit-slice of the vector x . For a fixed vector a there are 2^{N} possible values corresponding to 2^{N} binary vectors of length N that these inner products may take. For a reasonably moderate vector length N, all ofthese 2^{N} values may be pre-calculated and stored in a look-up table. Then the inner product (2) may be calculated in m iterations of fetch-shift-accumulate accumulate operations, where at the j th iteration, j=0, . . . , m−1, the inner product

$${\sum }_{k = 0}^{N - 1} {x}_{k , j} {a}_{k}$$

that corresponds to the j th bit-slice of the vector x is fetched from the look-up table, shifted by 2^{j} and then is accumulated to previously accumulated binary inner products.

Some of the drawbacks of DA include:
the real gain in the number of cycles needed for inner product implementation is achieved only by incorporating rather large look-up tables;
DA is bit-serial word-parallel in nature, whereas normally data are stored in a word-serial bit-serial (or rarely in word-serial bit-parallel) manner. This means data format conversion is needed prior DA implementation which occupies additional operating cycles and is also rather power consuming.
for each vector of fixed coefficients a a separate look-up table needs be created and stored.
even if many inner products with the same vector of fixed coefficients a need to be implemented in one task, computation of these inner products may not be efficiently implemented simultaneously unless the look-up-table for a is replicated. Thus the level of parallelism is restricted to the total number of all ports in all look-up table memories used.

Further background with regard to distributed arithmetics may be seen, for example, at a paper by Stanley A. White entitled APPLICATIONS OF DISTRIBUTED ARITHMETIC TO DIGITAL SIGNAL PROCESSING (IEEE ASSP Magazine, July 1989). DA is characterized there as generally employing arithmetic operations that are not ‘lumped’ in a familiar fashion but are rather distributed in an unrecognizable fashion, for example as sum of products (or in vector parlance, dot-product or inner-product generation).

There are many applications (such as software defined radio [SDR], image video compression/processing, 3^{rd} generation graphics, etc) where implementation of a very large number of inner products in parallel would bring a benefit. What is needed is an efficient method for implementing such large number of inner products in parallel.

Conventional DA implementations for inner product computations are based on a look-up table approach. A traditional ASP implementation of inner products would be based on implementing multiplications. Neither approach is efficient enough, and each carry several drawbacks mentioned above. It appears that the most common method for implementing inner product calculations is based on performing multiplications and additions or multiply-accumulate operations on traditional multipliers and adders or multiply-accumulate units. What is needed in the art is a more efficient flow of computations to perform inner product calculations, particularly in ASP and similar type processors.

### SUMMARY

The foregoing and other problems are overcome, and other advantages are realized, by the use of the exemplary embodiments of this invention.

In accordance with a first exemplary embodiment ofthis invention there is a method that includes storing subvector slices x(i, r, s) of a first vector x(i) in a bit-parallel word-serial manner, for each of the stored subvector slices and in parallel on bits of said each subvector slice, executing an operation that outputs a pre-calculated inner product result of the said bits and a second vector a; and outputting a result that depends from the executed operation

In accordance with a second exemplary embodiment of this invention there is a computer readable memory storing a program of instructions that are executable by a processor to take actions. In this embodiment the actions include storing subvector slices x(i,r,s) of a first vector x(i) in a bit-parallel word-serial manner; for each of the stored subvector slices and in parallel on bits of said each subvector slice, executing an operation that outputs a pre-calculated inner product result of the said bits and a second vector a ; and outputting a result that depends from the executed operation.

In accordance with a third exemplary embodiment of this invention there is an apparatus that includes a data storage array and a processor. In the data storage array there are subvector slices x(i,r,s) of a first vector x(i) which are stored in a bit-parallel word-serial manner. The processor is configured to execute an operation, on each of the stored subvector slices and in parallel on bits of said each subvector slice, that outputs a pre-calculated inner product result of the said bits and a second vector a.

In accordance with a fourth exemplary embodiment of this invention there is an apparatus that includes storage means (such as, for example a CAM array) and processing means (such as, for example an associative processor). The storage means is fir storing subvector slices x(i,r,s) of a first vector x(i) in a bit-parallel word-serial manner. The processing means is for executing an operation, on each of the stored subvector slices and in parallel on bits of said each subvector slice, that outputs a pre-calculated inner product result of the said bits and a second vector a.

### BRIEF SUMMARY OF THE DRAWINGS

FIG. 1 is a schematic block diagram showing functional architecture of a classical associative computing processor according to the prior art.

FIG. 2 is a reproduction of FIG. 2 of U.S. Pat. No. 6,405,281 showing a two-CAM array implementation of the processor of FIG. 1.

FIG. 3 is a high-level logic flow diagram that illustrates the operation of a method, and a result of execution of computer program instructions embodied on a computer readable memory, to perform DA in an ASP in accordance with the exemplary embodiments of this invention.

FIGS. 4a-e illustrates data organization and transformations for a CAM register and a tags register with respect to the process steps at FIG. 3 according to an exemplary embodiment of the invention.

FIGS. 5a-b are similar to respective FIGS. 4a and 4c but showing data organization and transformations particularly for moving window inner product computations such as FIR filtering type of operations according to an exemplary embodiment of the invention.

FIG. 6a shows a simplified block diagram of various electronic devices that are suitable for use in practicing the exemplary embodiments of this invention.

FIG. 6b shows a more particularized block diagram of a user equipment such as that shown at FIG. 6a.

### DETAILED DESCRIPTION

One technical advantage that exemplary embodiments of the invention provide is an efficient method for implementing a very large number of inner products in parallel. Specifically, these teachings detail a new high-performance approach for massively parallel implementation of computations. Examples of where such large matrix-vector computations may be implemented include matrix-vector product, FIR filtering, convolution, and discrete orthogonal transforms, to name a few. More precisely, the approach detailed herein combines two distinct techniques for high-speed computations: associative computing and the distributed arithmetic, and combines them in a manner that further increases the efficiency of the both.

One particular embodiment of these teachings is implementation of DA on ASPs, in particular for finite impulse response FIR filter (e.g., flexible-size FIR filtering type of operations) and/or cross-correlation operations which are frequently used for example in wireless communication algorithms. One technical advantage of these teachings is that the combined approach detailed herein overcomes drawbacks of the two separate approaches DA and ASC noted above, while synergistically combining their individual advantages.

These teachings may be applied to many fields of Information Technologies where high-speed implementation of matrix vector operations, in particular, inner product computations is needed. An important application in which these teachings may prove particularly advantageous is digital communications, and more specifically software defined radio (SDR) where several radio standards are to be implemented on a flexible programmable platform using hard real-time constraints. Implementation of the radio modems supporting these standards, in particular physical layer 1 (PHY L1) of long term evolution (LTE, or 3.9G) of universal mobile telecommunications system—terrestrial radio access network (UTRAN) and high speed data packet access (HSDPA). Implementations of these radio standards, such as in their related modems, require many matrix-vector operations such as fast Fourier transforms (FFT) and especially FIR filtering and cross-correlation operations of various sizes. Non-limiting examples below are in the context of flexible implementation of FIR filtering type of operations of variable sizes, or in other words, to variable size moving window inner product operations.

Other examples where these teachings maybe employed include image/video processing, pattern recognition, 3D-graphics, etc. For example, in the simplest image compression standard (JPEG) an image is split into blocks of a small size (typically 8×8) and then all the blocks are similarly processed by a series of algorithms (such as color conversion, discrete cosine transform, quantization, pre- or post-filtering), each of which is basically comprised of a set of inner product operations. All of these algorithms could be implemented over all the blocks in parallel. Even for relatively low resolution images, such as 1.3 megapixel images, a very high level of parallelism (approximately 20K blocks) could have been achieved if proper processors and proper implementation techniques was developed.

According to exemplary aspects of these teachings is an approach to implement inner products on associative processor arrays. Specifically, it would be desirable to implement DA on ASPs to execute various communication algorithms such as the FIR filtering and FFTs mentioned above. Such a technique would overcome drawbacks of the two approaches but would combine their advantages.

Consider again distributed arithmetics. For the case where there is a very large number N of components in each of the input vectors x(i) that are weighted and summed, to make feasible the direct approach that is noted in background above, an N-point inner product may be broken into N/n inner products each of the length n. This is equivalent to splitting the internal sum in (2) into shorter sums:

$$X = {\sum }_{r = 0}^{N / n - 1} {\sum }_{j = 0}^{m - 1} {2}^{j} \{ {\sum }_{k = 0}^{n - 1} {x}_{nr + k , j} {a}_{rn + k} \} \qquad ( 3 )$$

Then, instead of one single 2^{N}-word look-up table, one can use a number N/n of 2ⁿ-word look-up tables since the number of possible values that the innermost sum in the brace of equation (3) may take is 2ⁿ. Each inner product of length n is again calculated in m iterations. However, now there are N/n inner products to calculate and to accumulate to each other.

Consider the opposite problem, where N is too small to make the DA approach noted in background beneficial. For this instance one can group m bit-slices of equation (2) into m/p planes of depth p (or “p-planes”):

$$X = {\sum }_{s = 0}^{m / p - 1} {2}^{p s} \{ {\sum }_{k = 0}^{N - 1} {\sum }_{j = 0}^{p - 1} {x}_{k , sp + j} {2}^{j} {a}_{k} \} \qquad ( 4 )$$

Then there are m/p fetch-shift-accumulate iterations that need to be implemented instead of m fetch-shift-accumulate iterations. However, now there would be 2^{Np} different values for the sum in the brace of equation (4) that need be pre-calculated and stored.

With these generalizations for how to take the inner products, some of the advantages of DA approach are then:
the number of cycles to implement inner products may be reduced depending on the relation between N and m.
given task sizes m and N, parameters n and p may be varied to achieve maximum performance.
no multiplications are implemented.

Recalling the disadvantages listed in background for DA, certain of the exemplary embodiments of these teachings can easily solve those drawbacks where DA is implemented in associative processors.

As an initial matter, first combine equations (3) and (4) into a single general equation for DA so that the end solution is optimized for any size N. This then leads to the following equation:

$$X = {\sum }_{r = 0}^{N / n - 1} [ {\sum }_{s = 0}^{m / p - 1} {2}^{p s} \{ {\sum }_{k = 0}^{n - 1} {\sum }_{j = 0}^{p - 1} {x}_{nr + k , sp + j} {2}^{j} {a}_{k} \} ] \qquad ( 5 )$$

where n and p are DA parameters indicating a working inner product length and a working bit-depth, respectively.

In applications such as the inner products for radio communications noted above, there are many input vectors x(i)=[x₀⁽ⁱ⁾, . . . , x_{N-1}⁽ⁱ⁾]^{T}, i=0, . . . , L−1, for which inner products

$${X}_{l} = {\sum }_{r = 0}^{N / n - 1} [ {\sum }_{s = 0}^{m / p - 1} {2}^{p s} \{ {\sum }_{k = 0}^{n - 1} {\sum }_{j = 0}^{p - 1} {x}_{nr + k , sp + j}^{( l )} {2}^{j} {a}_{k} \} ] \qquad ( 6 )$$

need be calculated.

Clearly, explanation on a generic basis may soon become unclear to the reader due to the large number of input vectors being considered, and so a specific example will be used hereinafter: implementation of FIR filtering and cross-correlation type of operations which exemplify the general description of these teachings. This is also seen to be an embodiment in which the technical advantage of increased computational efficiency is quite pronounced. Specific examples of vectors on which the moving window embodiments may be implemented include interpolation filters or channel filters applied to received wireless communication signals; pre or post filtering of image rows and columns, particularly of video or gaming image data, but also for audio signals and/or for the purpose of de-noising image data. These are exemplary and not limiting to the broad and varied implementations for which these teachings may be employed.

In FIR filtering and cross-correlation type of operations, a vector of known fixed coefficients is multiplied to vectors that are formed by input signal samples entering into a window sliding across the long input signal. One can call this type of operations moving window inner products. If for example, we denote the FIR filter window size by N, the filter coefficient vector by a=[a₀, . . . , a_{N-1}], and the input signal by X=x₀,x₁, . . . , x_{N-1}, x_{N}, x_{N+1}, . . . , x_{M}, then the inner product b(i)=a·x(i) of the vector a with the vector x(i)=[x₁, . . . , x_{i+N-1}]^{T} is computed to obtain the i th output Xᵢ, i=0, . . . , L−1, (where L is the number of outputs, which is typically the same as the number of inputs M but here, without loss of generality, we allow it to be less than M for simplifying the equations).

Therefore equation (6) in this case is transformed to:

$${X}_{i} = {\sum }_{r = 0}^{N / n - 1} [ {\sum }_{s = 0}^{m / p - 1} {2}^{ps} \{ {\sum }_{k = 0}^{n - 1} {\sum }_{j = 0}^{p - 1} {x}_{nr + k + 1 , sp + 1} {2}^{j} {a}_{k} \} ] , i = 0 , … , L - 1 , \qquad ( 7 )$$

One can see from examining equation (7) that in this case the multiple vectors that participate in inner products with the vector a contain common components. This property may be used for more efficient utilization of ASP's CAM arrays for representing and processing of bit-slices in the innermost brace of equation (7).

The teachings according to this invention detailed below with particularity are seen to provide at least four distinct differences over the prior art DA or ASP implementations, summarized below.

First: there is an input data format rearrangement which enables application of the distributed arithmetic in the memory of the associative processor array. This is an important step in order to get the requisite processing efficiency, and this data format arrangement is especially efficient for implementing FIR filter or other operations involving calculation of inner products of a fixed vector with a plurality of other vectors involved in a window sliding across a long input vector. It is noted that an associative processor array could also be used solely for this purpose. It is well known that distributed arithmetic needs a data format which is not convenient to store in traditional memories. Traditional FIFO based conversion of the data format to a suitable one is known to be power consuming. This data format conversion is therefore important to achieve the efficiencies possible by these teachings.

Second: the distributed arithmetic technique is applied without a need to store pre-calculated binary inner products in look-up tables. This alone is seen fundamentally different from the underlying principles of DA.

Third: parallelization of the distributed arithmetics. In a traditional look-up table based implementation of the distributed arithmetic, the level of parallelization is restricted to the common number of all ports of all look-up tables used, whereas in the associative processor based method the level of parallelization is only restricted by the size of the associative processor's memory.

Fourth: a multiplication-less method of implementing inner products on associative processors. The conventional associative processor-based method for implementing inner products would involve multiplications which are rather slow on associative processors.

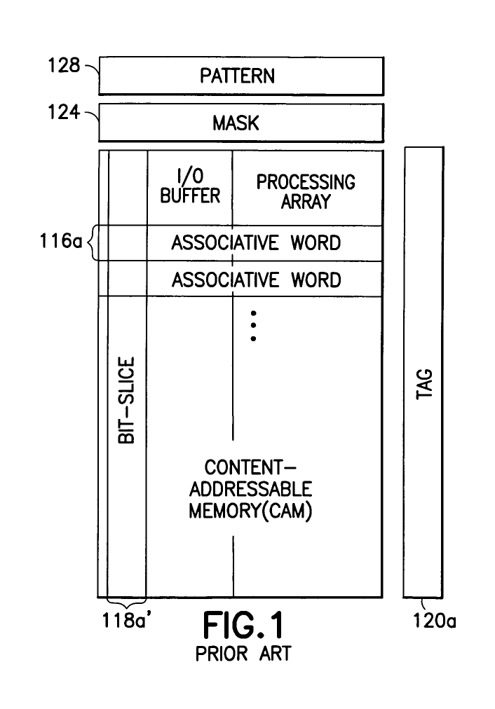

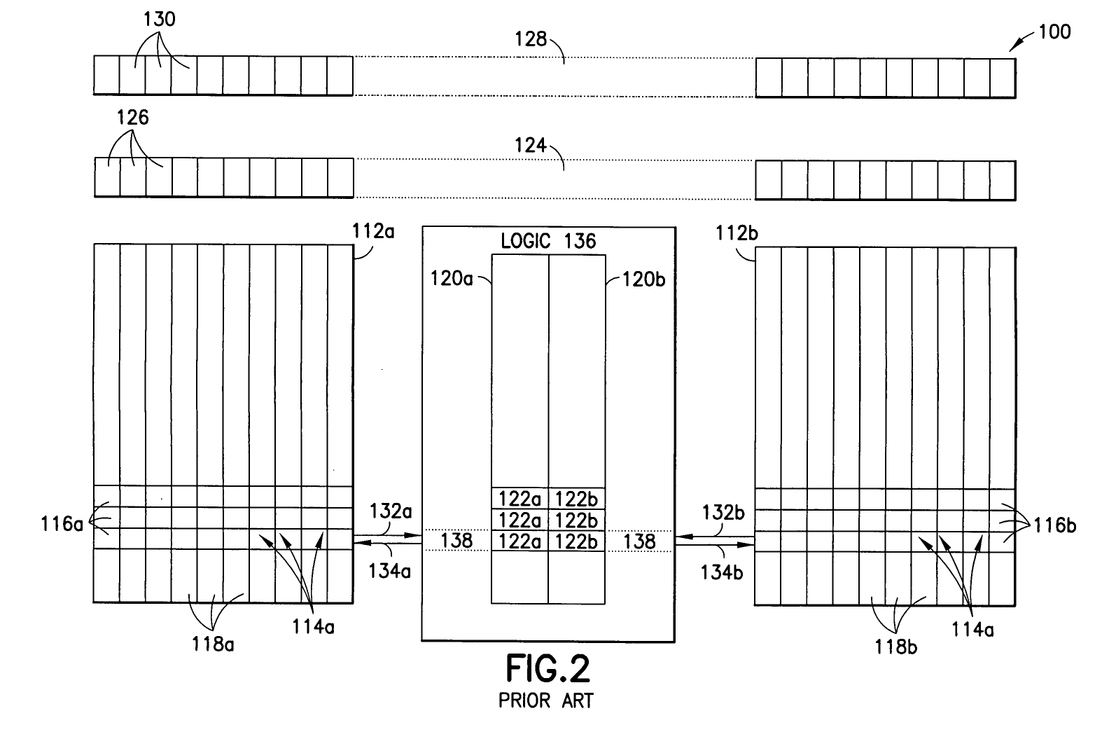

With those guideposts in mind, we now detail how computations according to equation (6) and by example for FIR filtering type of operations in particular, computations according to (7) are implemented on associative processors according to an exemplary and non-limiting embodiment. For simplicity, this particular description is provided for associative processors consisting of a single CAM array and a single tags register such as the arrangement shown at FIG. 1. The results are straightforward to translate to the more general case of several CAM arrays and several flexible tags registers inside the associative processor as is the case at FIG. 2.

Furthermore, it can be shown that in most of the practical cases of implementing DA on ASPs, the optimal choice for p in equations (6) and (7) is p=1. Therefore, we will use this value of p in describing the preferred embodiments and in the illustrations.

Equations (6) and (7), for the case p=1 may be rewritten as

$$\begin{matrix}{X}_{i} = {\sum }_{r = 0}^{N / n - 1} [ {\sum }_{s = 0}^{m - 1} {2}^{s} \{ {\sum }_{k = 0}^{n - 1} {x}_{rn + k , s}^{( i )} {a}_{rn + k} \} ] = {\sum }_{r = 0}^{N / n - 1} [ {\sum }_{s = 0}^{m - 1} {2}^{s} a ( r ) x ( i , r , s ) ] \\ and & ( 8 ) \\ {X}_{i} = {\sum }_{r = 0}^{N / n - 1} [ {\sum }_{s = 0}^{m - 1} {2}^{s} \{ {\sum }_{k = 0}^{n - 1} {x}_{nr + k + i , s} , {a}_{m + k} \} ] = {\sum }_{r = 0}^{N / n - 1} [ {\sum }_{s = 0}^{m - 1} {2}^{s} a ( r ) x ( i , r , s ) ] & ( 9 )\end{matrix}$$

respectively, where we have denoted x(i,r,s)=[x_{nr,s}⁽ⁱ⁾, x_{nr+1,s}⁽ⁱ⁾, . . . , x_{n(r+1)-1,s}⁽ⁱ⁾]^{T} be the s th, s=0, . . . , m−1, bit-slice of the r th r=0, . . . , N/n−1 subvector of the vector x(i) that is multiplied to the r th subvector a(r)=[aₙᵣ, aₙᵣ₊₁, . . . , aₙ₍ᵣ₊₁₎₋₁]^{T} of the vector a according to (8).

In the case of moving window inner product operations [denoted by equation (9)], x(i,r,s)=[x_{nr+i,s}, x_{nr+i+1,s}, . . . , x_{n(r+1)+l-1,s}]^{T}. Let us note that, in this case, x(i+ln,r,s)=x(i,r+l,s), for any integer l such that 0<i+ln<L−1 and 0<r+l<N/n−1. This in particular means that once stored in the CAM memory in a needed format, the same subvector may be reused for computation of several outputs.

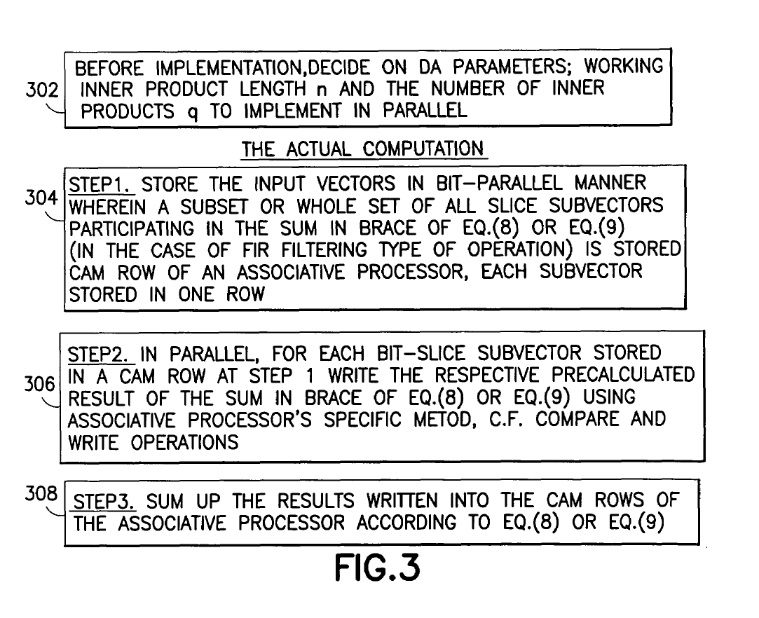

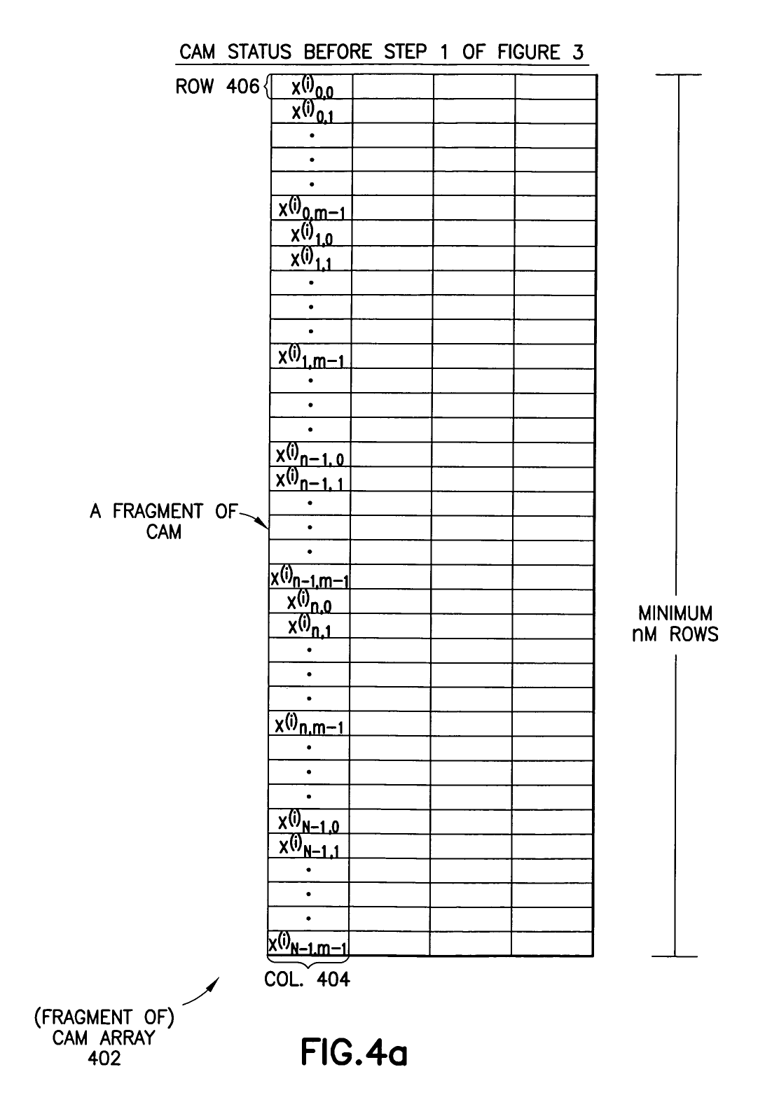

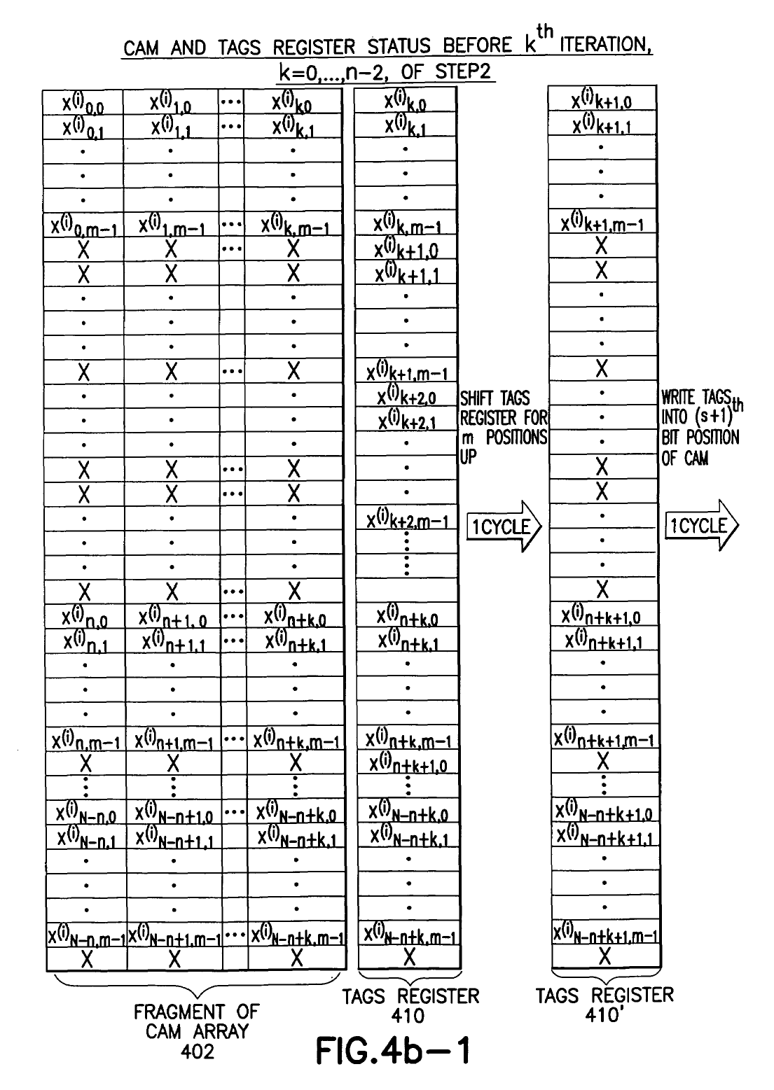

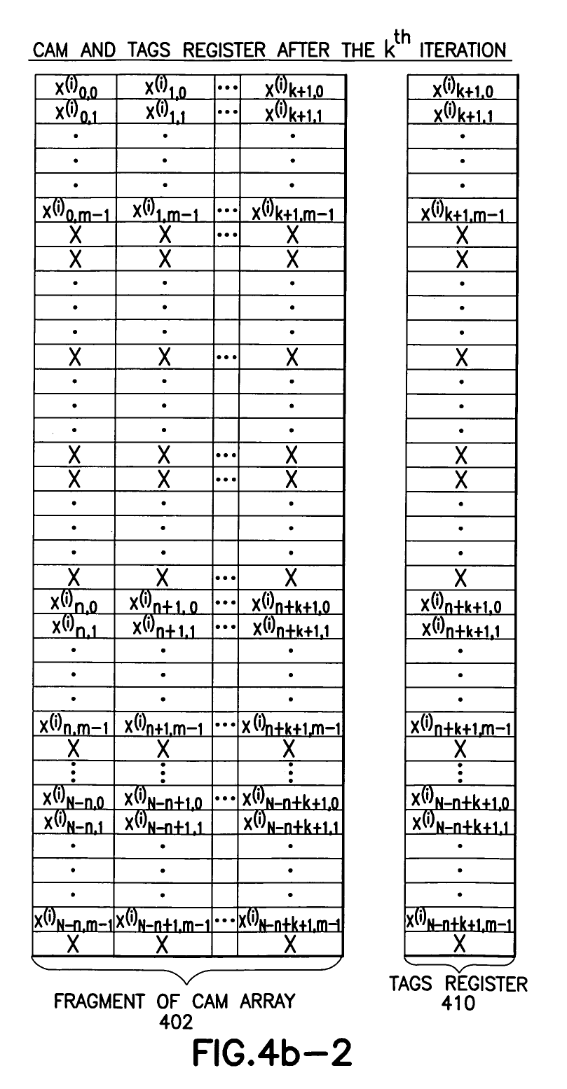

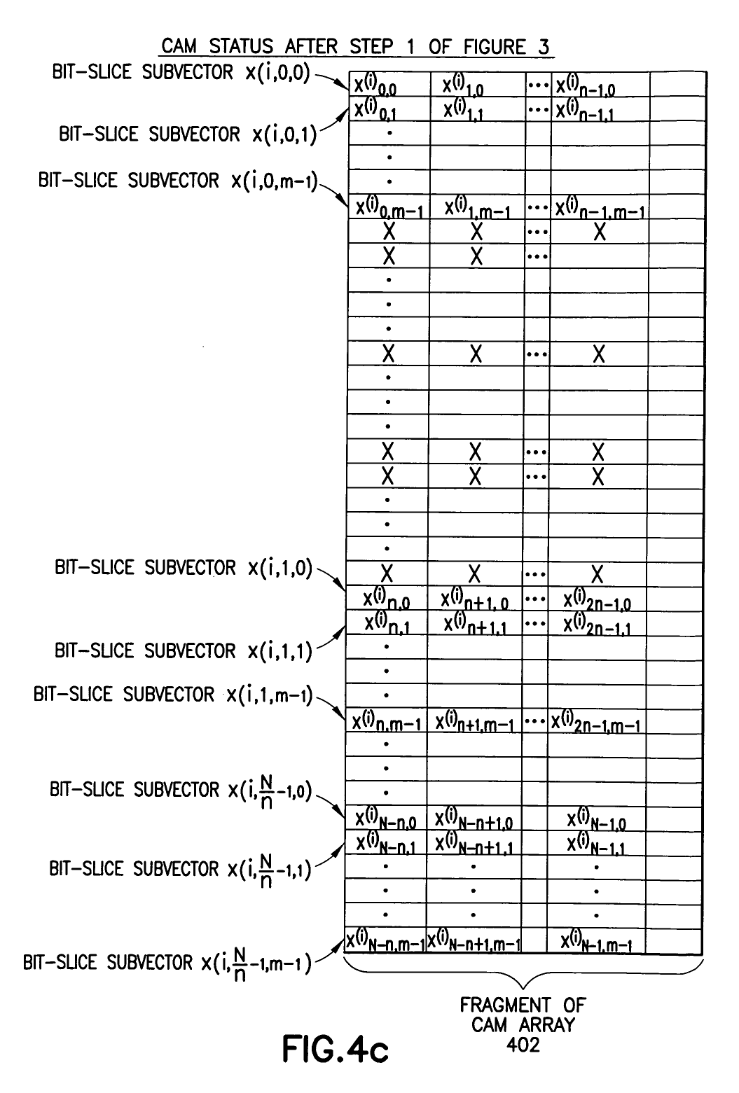

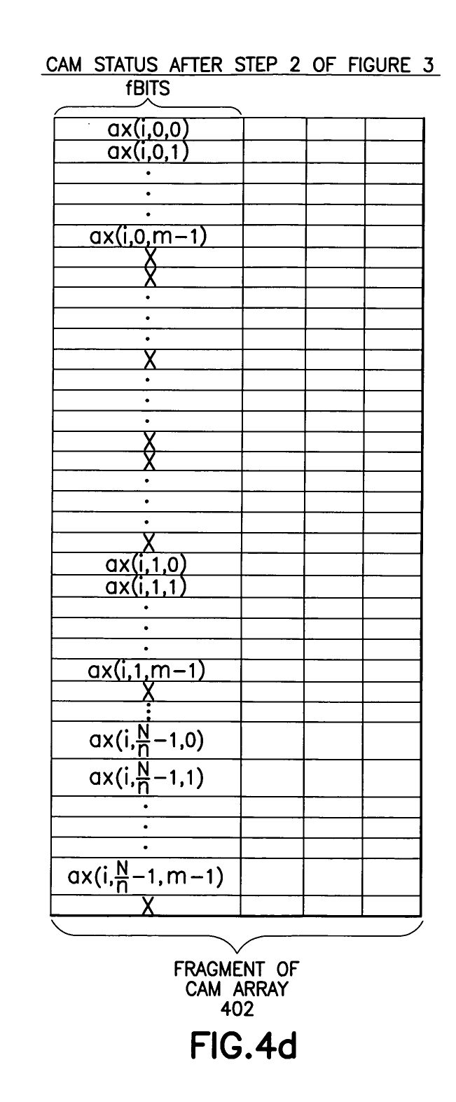

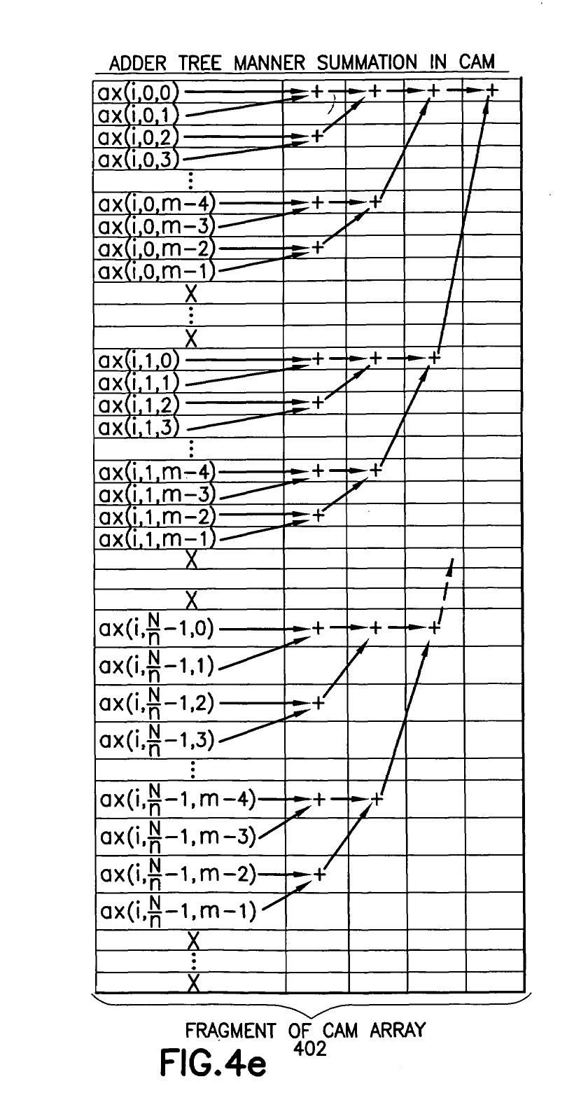

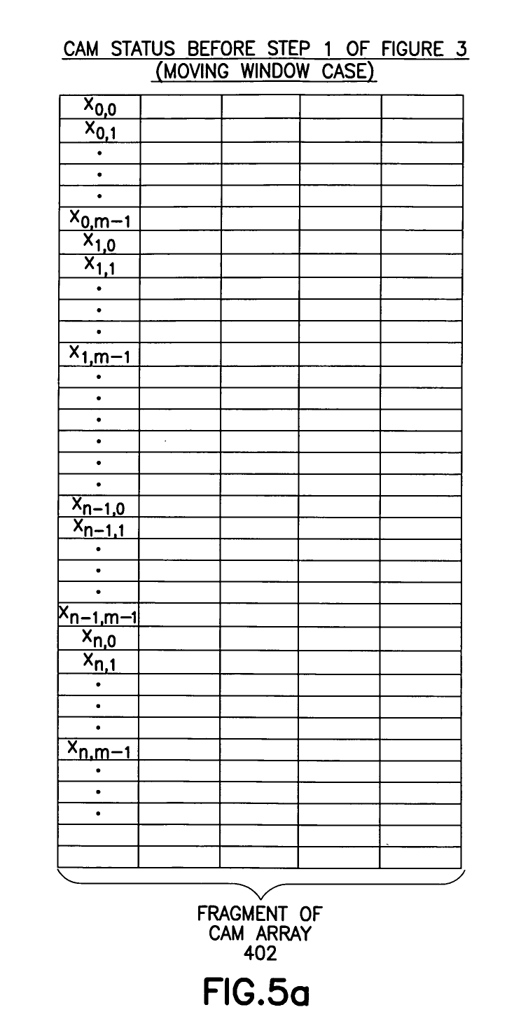

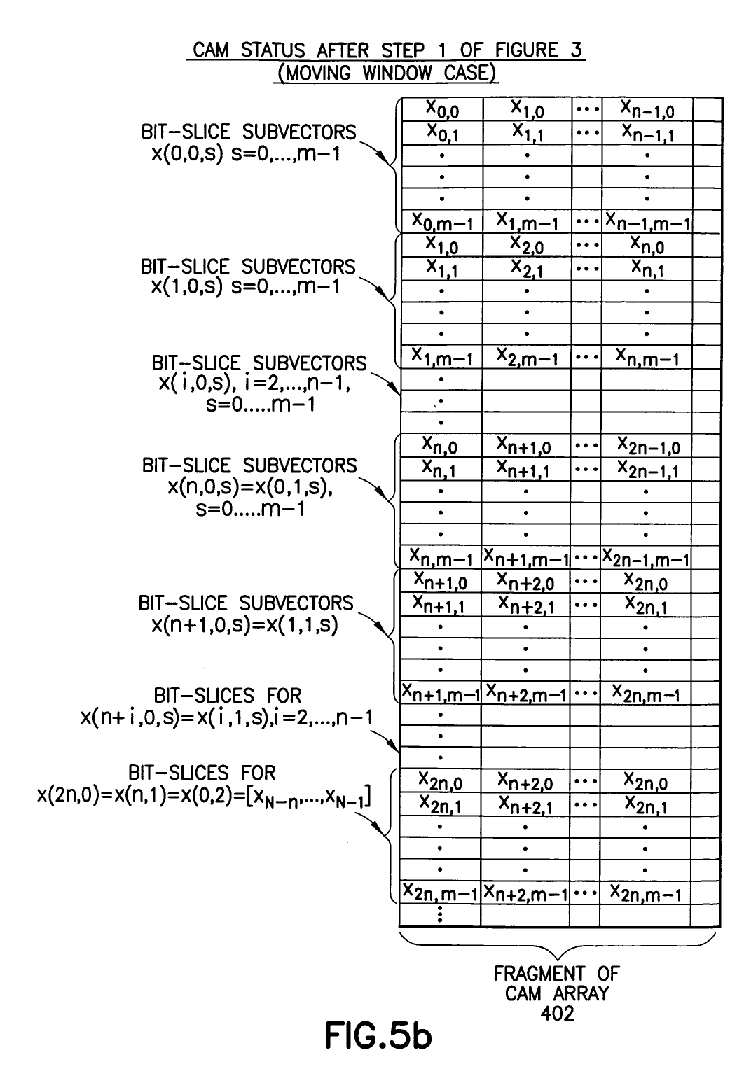

FIG. 3 illustrates a high-level block diagram showing the main steps of an exemplary embodiment according to these teachings for executing distributed arithmetics on an associative processor. Before the actual inner product computations are begun, at block 302 parameters in the DA representation (6), such as working inner product length n and a working bit-depth p as well as the number of inner products that may preferably be implemented in parallel are initially decided. As mentioned above the following description implies the case of p=1.

At the beginning of the actual implementation, we assume that input vectors x(i), i=0, . . . , L−1, are written in the CAM array 402 of the associative processor in the conventional bit-serial manner as shown in FIG. 4a for one of these vectors. As seen at FIG. 4A, one vector is written to one column 404 of the array 402: x⁽ⁱ⁾_{k,j} denotes the j th bit j=0, . . . , m−1 of the k th, k=0, . . . , N−1 component of the vector x(i), i=0, . . . , L−1. For simplicity, we assume mNL is smaller than or equal to the CAM array length (the number of rows in the full CAM array). Note that FIG. 4A illustrates only a portion or fragment of a full CAM array in that only some of the rows are illustrated. Thus the depicted “minimum nM rows” are those rows of the full CAM array in which the vector x(i) is stored.

At block 304 of FIG. 3, the bits of the vectors x(i), i=0, . . . , L−1, are rearranged so that each subvector slice x(i,r,s) in equation (8) is written in one associative row 406 of the ASP CAM array 402 as shown at FIG. 4c. For this, the bits of the vectors x(i), i=0, . . . , L−1, (which were stored according to FIG. 4a) are copied to the tags register 410 in parallel by implementing one “Compare” instruction with a broadcast “1” signal (so that no bits are masked or otherwise de-selected). Next, n−1 iterations of shift-write are implemented as illustrated at FIG. 4b (shown as 4b-1 and 4b-2).

The iterations are indexed as k=0 . . . n−1 and denote the component of the subvector x(i,r,s) as in equations (8) and (9). FIGS. 4b-1 and 4b-2 illustrate one of those k iterations, and FIG. 4c illustrate the end result after all of the k=n−1 iterations are executed which place the input subvectors x(i,r,s), which were stored in bit-serial word serial manner as shown at FIG. 4a, to the bit-parallel word serial manner where all the bits of each of those same x(i,r,s) subvectors are written inside one associative word (inside one CAM row) as in FIG. 4c, and therefore accessible for “Compare” operations all in parallel. The bit-serial word-serial manner shown at FIG. 4a is characterized in that the bits of the sequential subvector slices x(i,r,s) of the input vector x(i) are stored serially along a column 404 of the CAM array. The bit-parallel word-serial manner shown at FIG. 4c is characterized in that bits of each of the subvector slices x(i,r,s) of the input vector x(i) are stored in one row (so that each bit of a subvector slice can be accessed in parallel), and the different subvector slices are stored serially in the different rows so that each row bears one of the different subvector slices (and the corresponding bit positions of the different-row subvector words are aligned by column). It is noted that columns and rows as used herein are termed as such for convenience; merely rotating the CAM array may invert the characterization of columns and rows but does not escape the teachings set forth herein or the claims set forth below.

Consider the transforms shown at FIGS. 4b-1 and 4b-2. The purpose of the k^{th} iteration, k=0, . . . , n−2 is to bring the (k+1)^{th} components x⁽ⁱ⁾ₙᵣ₊ₖ of each subvector x(i,r,s) to the correct place according to FIG. 4c. Note that all the 0^{th} components are already in their correct places (compare FIGS. 4a and 4c). Thus in the beginning of k^{th} iteration the bit slices of components 0, . . . , k of each subvector x(i,r,s) are in their “correct” places, wherein “correct” refers to the intended final location shown at FIG. 4c for the parallel “Compare” operations. After this k^{th} iteration we want to bring also components k+1 of each of these subvectors to their correct places. Note that prior to the beginning of these iterations the desired bits of components k+1 of subvectors x(i,r,s) were stored in rows (as depicted at FIG. 4a), which are below for (k+1)m positions compared to the rows where we want to bring them. In this iterative transformation the content of the tags register is shifted upward for m positions in each iteration. Therefore, in the beginning of the k^{th} iteration the tags register contains the desired bits of components k+l of each subvectors x(i,r,s) in the positions that are m below compared to the target positions. Therefore, our target of writing these components according to FIG. 4c, may be accomplished in two cycles, where in the first cycle the tags register is shifted up for m positions and in the second cycle the shifted tags register content is copied to the CAM column next to the column where bits of components k of subvectors x(i,r,s) were written in iteration k−1. Clearly after n−1 such iterations all the bits will be re-arranged according to FIG. 4c.

The X'd out cells of the CAM array at FIGS. 4b-1 and 4b-2 indicate that the information in those cells is irrelevant to the parallel Compare operations for which these iterations are arranging the data. Thus at FIG. 2c it is seen that all of those irrelevant data points (cells) are arranged in associative words (rows) within the CAM array. Since no row has both relevant and irrelevant data in any column that is to be involved in the “Compare” operation, then the Compare operation may be executed only on those rows bearing the relevant data. Thus in every instance where a Compare operation is executed in parallel across a row, each and every Compare yields useable data; there is no cell in any row for which a Compare operation is done for which the result is ignored (as would be the case if there were irrelevant data points aligned to a column in which a “Compare” operation is done). For the case where any single row has only irrelevant data points as seen at FIG. 4c, no Compare operation needs to be executed on any of those single rows.

As the result of the transform which occurs through the k=n−1 iterations, the input bits are rearranged into an order where each bit-slice of each subvector x(i,r,s), i=0, . . . , L−1, r=0, . . . , N/n−1, s=0, . . . , m−1, participating in computation of one binary product in equation (8), is written in one associative word.

In an arrangement for implementing the moving window FIR type of operation according to this specific example, the input vectors have common components. Arrangement of the bits before block 304 of FIG. 3 is shown at FIG. 5a, and the resulting rearrangement of the bits that result from that block 304 are shown at FIG. 5b. These are similar in relevant respects to the more general case shown at respective FIGS. 4a and 4c, but showing detail for the moving window inner products. At FIGS. 5a-b, x_{q,p}, p=0, . . . , m−1, q=0, . . . , M is the p th bit of the input sample x_{q}. The procedure of rearrangement is exactly the same as in the general case shown at FIG. 4b. It is noted that there are more active (enabled) CAM rows utilized in the case of the FIR filtering type of operations (in fact all rows are used as seen at FIG. 5b) as compared to the general case depicted at FIG. 4c. Therefore, full parallelization may be achieved in this exemplary embodiment.

Note that there are no X'd out bits/cells for the specific embodiment of FIGS. 5a-b. FIG. 5a illustrates the arrangement of the input subvectors x(i,r,s) being stored in bit-serial word serial manner similar to that described for FIG. 4a. FIG. 5b illustrates the end result after all of the k=n−1 iterations are executed, in which all the bits of each of those same x(i,r,s) subvectors are written inside one associative word (inside one CAM row) as was described for FIG. 4c. There are no X'd out cells/bits at FIGS. 5a-5b because in this moving window embodiment implementing equation (7), all of the bits are relevant and none are excluded from the parallel Compare operations.

The complexity of block 304 (FIG. 3) is Cₛₜₑₚ₁=2n−1 machine cycles;: one cycle for the “Compare” operation to copy the input bits into the tags register; and n−1 iterations each consuming two machine cycles for shift and for write, respectively.

Moving now to block 306 of FIG. 3, in parallel for each bit slice subvector stored in a row 406 of the CAM array 402 as a result of block 304, the ASP writes the respective pre-calculated result of the sum of the relevant inner products, which are shown as that sum within the braces of either equations (8) or (9) depending on whether we are using the more general case (equation 8) or the specific moving window case (equation 9). The write operation can use whichever of several possible specific methods the ASP implements, which by the general description in the background section is assumed to be compare-and-write. There are then 2ⁿ iterations of compare-write being implemented.

At each iteration t=0, . . . , 2ⁿ−1, a next possible binary vector t of length n is first compared in parallel to all the binary slices written into the ASP's associative rows 406 at block 304/Step 1 of FIG. 3. The tags register bits are set to the binary value “1” for all and only those associative rows which contain the binary vector t. Then, the pre-calculated result at^{T} written in the corresponding field of the ASP's pattern register 128 is written into output fields of those rows for which the tags register bit was set to “1”. This is a usual associative computing procedure.

Clearly at the end of 2ⁿ compare-write iterations, binary products a(r)*x(i,r,s) of all the subvectors x(i,r,s), i=0, . . . , L−1, r=0, . . . , N/n−1 written to the ASP's associative rows 406 at block 304/Step 1 with the corresponding subvectors a(r) will be computed. Therefore at the end of block 306/Step 2, all the binary products participating in equation (8) (in the general case) or in equation (9) (in the case of moving window inner products) will be computed and stored in corresponding associative rows 406 of the ASP, which is shown specifically at FIG. 4d.

It follows that the complexity of block 306/Step 2 of FIG. 3 is Cₛₜₑₚ₂=2ⁿ⁺¹ machine cycles.

Now consider block 308/Step 3 of FIG. 3. The binary inner products shown at FIG. 4d are summed up according to equation (8) in the general case or according to equation (9) in the case of FIR filtering type of operations (moving widow inner products). Different summation procedures may be applied. One specific implementation to do this summation utilizes an adder tree principle, and is illustrated at FIG. 4e.

Note that there are N/n groups, each consisting of m addends (see (8) and (9)). Therefore, there are

$$log ( \frac{Nm}{n} )$$

stages of parallel additions to accomplish in order to sum up all the binary inner products of equations (8) or (9). Before implementing each of these stages one needs to arrange the addends so that pairs participating in one addition are written in the same associative word of the ASP. It is easy to see that this rearrangement may be implemented in at most 2f machine cycles of shift and write, where f is the number of bits of the binary inner products obtained at block 306/Step 2. Therefore, the complexity of block 308/Step 3 of FIG. 3 can be estimated as

$${C}_{step 3} = log ( \frac{Nm}{n} ) {C}_{add} ( \tilde{m} ) + 2 f ,$$

where C_{add}(\tilde{m}) is the complexity of \tilde{m}-bit additions where \tilde{m} is the output precision.

Definitely, C_{add}(\tilde{m})≦8 \tilde{m}, where the upper bound 8 \tilde{m} of complexity corresponds to the above described parallel addition procedure detailed for ASP processing in background above. Thus, the complexity of block 308/Step 3 may be estimated as

$${C}_{step 3} = log ( \frac{Nm}{n} ) {C}_{add} ( \tilde{m} ) + 2 f \leq 8 \tilde{m} log ( \frac{Nm}{n} ) + 2 f$$

machine cycles.

Now consider that up to Q=T/(mN) inner products of length N may be computed in parallel by the exemplary approach above, where T is the number of rows 406 in the CAM array 402 of the ASP. The total complexity then for these Q inner products may be evaluated as:

$${C}_{proposed\_method} ( N , Q ) = 2 ( n + f ) + {2}^{n + 1} + log ( \frac{Nm}{n} ) {C}_{add} ( \tilde{m} ) - 1 \leq {2}^{n + 1} + 8 log ( \frac{Nm}{n} ) \tilde{m} + 2 ( n + f ) - 1.$$

In the case of FIR filtering type of operations, the complexity is given by the same formula but for S=T/m=NQ output samples. The comparatively higher performance is achieved due to a higher degree of CAM row utilization noted above, and therefore a higher level of parallelism. The complexities of the above exemplary computational approach per one inner product may be estimated as:

$${C}_{proposed\_method} ( N , 1 ) = \frac{( 2 ( n + f ) + {2}^{n + 1} + log ( \frac{Nm}{n} ) {C}_{add} ( \tilde{m} ) - 1 ) mN}{T} \leq \frac{mN {2}^{n + 1} + 8 m \tilde{m} N log ( \frac{Nm}{n} ) + 2 ( n + f ) mN - mN}{T}$$

in the general case, and for the specific moving-window case as:

$${C}_{proposed\_method \_Fir} ( N , 1 ) = \frac{( 2 ( n + f ) + {2}^{n + 1} + log ( \frac{Nm}{n} ) {C}_{add} ( \tilde{m} ) - 1 ) m}{T} \leq \frac{m {2}^{n + 1} + 8 m \tilde{m} log ( \frac{Nm}{n} ) + 2 ( n + f ) m - m}{T} .$$

Typically N and m are much smaller than T. For example in radio modems, typically N<125 and m=8 or m=16, while, as mentioned above a typical value for T is T=2¹⁶.

As an illustration of the computational efficiency improvements these teachings may offer, now are compared the complexity of the above exemplary embodiments to that of three conventional methods.

First is compared a conventional multiply-accumulate (MAC) based implementation of Q inner products. Assuming an architecture that involves P MAC units, the complexity of the MAC based method per inner product may be estimated as

$${C}_{MAC\_metghod} ( N , 1 ) = \frac{N}{P} \cdot {C}_{MAC} ( m )$$

machine cycles where C_{MAC}(m) is the number of machine cycles for m-bit MAC operation. Since in the exemplary embodiments detailed above the value of T is assumed be very large (up to 2¹⁶) and the value of n is a parameter that may be optimized and since most of the practical architectures contain a moderate number P of MAC units (usually P≦16), a significant complexity reduction may always be achieved by these exemplary embodiments as compared to the MAC-based one.

Next is compared the exemplary embodiments detailed above to a conventional distributed arithmetics approach. Assume a distributed arithmetic's architecture utilizing a memory of the same total size of T words as the assumed associative processor in the exemplary embodiments of these teachings. Then a total of

$$\frac{T}{{2}^{n}}$$

parallel look-up tables, each of the size 2ⁿ, may be utilized to implement computations according to equations (8) or (9) in parallel for

$$\frac{T}{{2}^{n}}$$

inner products. As an aside it is noted that the property of FIR filtering type of operations that input vectors are overlapping is additionally difficult to utilize in DA. Now assuming

$$\frac{Nm}{n}$$

adders are available, then

$${C}_{DA} ( T / {2}^{n} ) = log ( \frac{NM}{n} ) \cdot {C}_{+} ( m )$$

machine cycles are needed in order to implement shift-additions according to equations (8) (or (9)), where C₊(m) is the number of machine cycles for one m-bit addition with a conventional adder. Therefore, the complexity per one inner product for the conventional distributed arithmetics technique is estimated as:

$${C}_{DA} ( N , 1 ) = \frac{T}{{2}^{n}} log ( \frac{NM}{n} ) \cdot {C}_{+} ( m ) .$$

Since T is a large number a clear complexity gain is again evident.

Finally, let us compare the exemplary embodiments detailed above to a conventional associative computing approach. In this case, T/m inner products could in parallel be computed according to equation (1) utilizing the same ASP as in the exemplary embodiments according to these teachings. Assuming that the complexity of one m-bit multiplication on the ASP is C_{mpy}(m), and the complexity of one m-bit addition on the ASP be C_{add}(m), there are then C_{ASP}(T/m)=NC_{mpy}(m)+(N−1)C_{add}(m) machine cycles needed to implement computations according to equation (1). Therefore, the complexity per inner product for the conventional associative processing technique is estimated as:

$${C}_{ASP} ( N , 1 ) = \frac{( {NC}_{mpy} ( m ) + ( N - 1 ) {C}_{add} ( m ) ) m}{T} .$$

Since C_{mpy}(m)=O(m²) while C_{add}(m)=O(m), and since the complexity of the exemplary embodiments according to these teachings can be varied by varying the value of n, a significant gain is again evident, especially in the case of FIR filtering type of operations.

By the above comparison, clearly the combination of DA with ASC as detailed herein provides a synergistic gain over either independent prior art approach.

So in summary, some of the advantages offered by specific exemplary embodiments according to these teachings include:
an extremely low number of clock cycles to implement many inner products (especially, in the case of FIR filters and cross-correlations), due to a high degree of parallelism enabled by the ASP and efficient multiplication-free computation enabled by the DA technique;
no look-up-tables need be stored;
there is flexibility with respect to such parameters as the length of the inner product, the bit-width of the inputs and coefficients;
there is the possibility to optimize implementation depending on the above parameters.

These teachings are seen to be so divergent from what is known to the inventors as being within the prior art that implementation may require in some instances new programming models and possibly new programming skills to exploit advantages of the invention. Further, depending on data storage format in the main memory of the system and depending on the input/output (I/O) types supported by the ASP, there may be some early adoption difficulties in organizing data in the CAM arrays in the format needed for implementing these teachings in the most efficient manner. This may however be solved by modifications in ASC principles and by introducing some modifications to ASP architectures to fully exploit the computational efficiency and high levels of parallelism that is the potential of this technique.

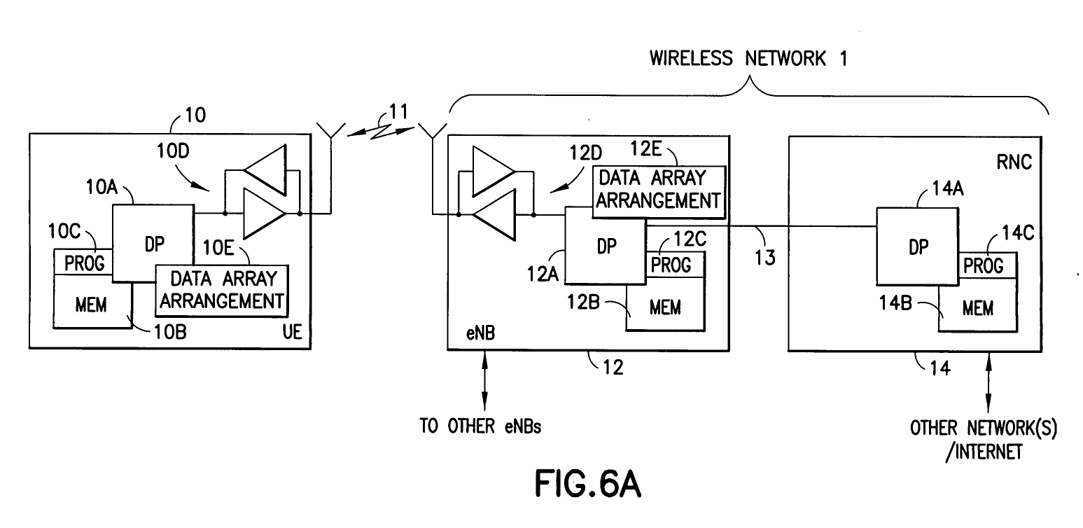

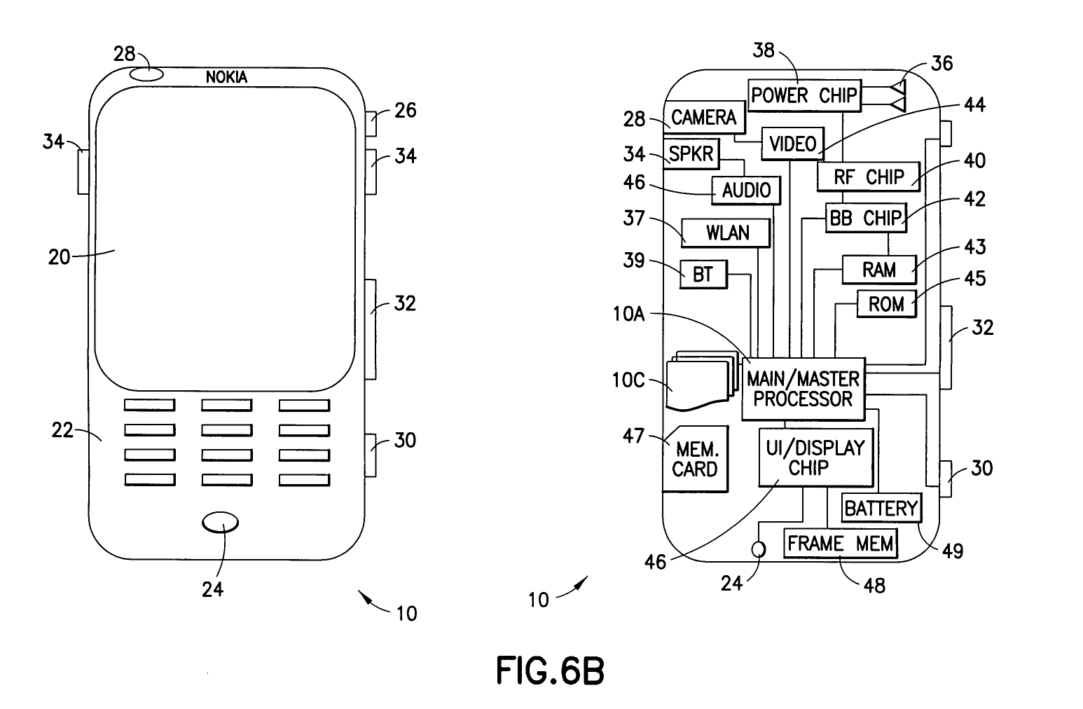

Embodiments of the invention may be advantageously deployed in elements of a communication system, such as in chips/processors and/or software embodied in a memory of a user equipment or access node of a wireless communication system. FIGS. 6a-b illustrate several such elements/electronic devices arranged in an exemplary wireless system. In FIG. 6a a wireless network 1 is adapted for communication over a wireless link 11 with an apparatus, such as a mobile communication device which may be referred to as a user equipment UE 10, via a network access node 12, such as a Node B (base station), which may be an eNB of an LTE system, an access point of a wireless local area network, a home eNB, a relay station, and the like. The network 1 may include a network control element (NCE) 14 that may include functionality for a mobility management entity/serving gateway MME/S-GW as is known in the art for the LTE system for providing connectivity with a network 1, such as a telephone network and/or a data communications network (e.g., the internet).

The UE 10 includes a controller, such as a computer or a data processor (DP) 10A, a computer-readable memory medium embodied as a memory (MEM) 10B that stores a program of computer instructions (PROG) 10C, and a suitable radio frequency (RF) transceiver 10D for bidirectional wireless communications with the eNB 12 via one or more antennas. The eNB 12 also includes a controller, such as a computer or a data processor (DP) 12A, a computer-readable memory medium embodied as a memory (MEM) 12B that stores a program of computer instructions (PROG) 12C, and a suitable RF transceiver 12D for communication with the UE 10 via one or more antennas. The eNB 12 is coupled via a data/control path 13 to the NCE 14. The path 13 may be implemented as the S1 interface shown in FIG. 1. The eNB 12 may also be coupled to another eNB via data/control path 15, which may be implemented as an X2 interface of the LTE system.

At least one of the PROGs 10C and 12C is assumed to include program instructions that, when executed by the associated DP, enable the device to operate in accordance with the exemplary embodiments of this invention, as will be discussed below in greater detail.

That is, the exemplary embodiments of this invention may be implemented at least in part by computer software executable by the DP 10A of the UE 10 and/or by the DP 12A of the eNB 12, or by hardware, or by a combination of software and hardware (and firmware).

For the purposes of describing the exemplary embodiments of this invention the UE 10 may be assumed to also include an ASP data array 10E, and the eNB 12 may include also its own ASP data array arrangement 12E, such data array arrangements include at least a data array 402 with storage units in rows 406 and columns 404, a tags array 410 which may be one or more rows or columns apart from the other data array 402, a mask array 124 which may also be one or more rows or columns apart from the other data array 402 and from the tags array 410, and a pattern array 128 which may also be one or more rows or columns apart from the other data array 402 and from the tags array 410 and from the mask array. The data array arrangements 10E, 12E may be similar in relevant respects to that shown by example at FIGS. 1 and/or 2, but in which the data stored therein is manipulated according to these teachings by the associated DP 10A, 12A or other processors shown at FIG. 6b. Such data array arrangements 10E, 12E may be within the MEMs 10B, 12B, or may be on-chip memory, or may be another of the memory types shown at FIG. 6b.

In general, the various embodiments of the UE 10 can include, but are not limited to, any of the following exemplary devices which have wireless communication capabilities, and/or image processing (e.g., compression) capabilities: cellular telephones, personal digital assistants (PDAs), portable computers, image capture devices such as digital cameras, gaming devices (particularly those having 3-dimensional image processing capacity), music storage and playback appliances, Internet appliances permitting wireless Internet access and browsing, as well as portable units or terminals that incorporate combinations of such functions.

The computer readable MEMs 10B and 12B may be of any type suitable to the local technical environment and may be implemented using any suitable data storage technology, such as semiconductor based memory devices, flash memory, magnetic memory devices and systems, optical memory devices and systems, fixed memory and removable memory. The DPs 10A and 12A may be of any type suitable to the local technical environment, and may include one or more of general purpose computers, special purpose computers, microprocessors, digital signal processors (DSPs) and processors based on a multicore processor architecture, as non-limiting examples.

FIG. 6b illustrates further detail of an exemplary UE in both plan view (left) and sectional view (right), and the invention may be embodied in one or some combination of those more function-specific components. At FIG. 6b the UE 10 has a graphical display interface 20 and a user interface 22 illustrated as a keypad but understood as also encompassing touch-screen technology at the graphical display interface 20 and voice-recognition technology received at the microphone 24. A power actuator 26 controls the device being turned on and off by the user. The exemplary UE 10 may have a camera 28 which is shown as being forward facing (e.g., for video calls) but may alternatively or additionally be rearward facing (e.g., for capturing images and video for local storage). The camera 28 is controlled by a shutter actuator 30 and optionally by a zoom actuator 30 which may alternatively function as a volume adjustment for the speaker(s) 34 when the camera 28 is not in an active mode.

Within the sectional view of FIG. 6b are seen multiple transmit/receive antennas 36 that are typically used for cellular communication. The antennas 36 may be multi-band for use with other radios in the UE. The operable ground plane for the antennas 36 is shown by shading as spanning the entire space enclosed by the UE housing though in some embodiments the ground plane may be limited to a smaller area, such as disposed on a printed wiring board on which the power chip 38 is formed. The power chip 38 controls power amplification on the channels being transmitted and/or across the antennas that transmit simultaneously where spatial diversity is used, and amplifies the received signals. The power chip 38 outputs the amplified received signal to the radio-frequency (RF) chip 40 which demodulates and downconverts the signal for baseband processing. The baseband (BB) chip 42 detects the signal which is then converted to a bit-stream and finally decoded. Similar processing occurs in reverse for signals generated in the apparatus 10 and transmitted from it.

Signals to and from the camera 28 pass through an image/video processor 44 which encodes and decodes the various image frames. A separate audio processor 46 may also be present controlling signals to and from the speakers 34 and the microphone 24. The graphical display interface 20 is refreshed from a frame memory 48 as controlled by a user interface chip 50 which may process signals to and from the display interface 20 and/or additionally process user inputs from the keypad 22 and elsewhere.

Certain embodiments of the UE 10 may also include one or more secondary radios such as a wireless local area network radio WLAN 37 and a Bluetooth® radio 39, which may incorporate an antenna on-chip or be coupled to an off-chip antenna. Throughout the apparatus are various memories such as random access memory RAM 43, read only memory ROM 45, and in some embodiments removable memory such as the illustrated memory card 47 on which at least some of the various programs 10C may be stored. All of these components within the UE 10 are normally powered by a portable power supply such as a battery 49.

The aforesaid processors 38, 40, 42, 44, 46, 50, if embodied as separate entities in a UE 10 or eNB 12, may operate in a slave relationship to the main processor 10A, 12A, which may then be in a master relationship to them. Embodiments of this invention may be seen at one or multiple components within the UE 10 or eNB 12. For example, embodiments of this invention may be seen at the baseband processor/chip 42 for the case of processing radio-frequency signals, at the video processor/chip 44 for the case of processing still or moving image data that is input from the camera 28 (or image data received over a wireless link 11 via the antennas 36), at the audio processor/chip 46 for the case of processing audio data received over some download link, and at the WLAN processor/chip 37 and/or possibly also at the Bluetooth processor/chip 39 for non-cellular wireless signal processing. It is noted that other embodiments need not be disposed in any of those processors individually but may be disposed across various chips and memories as shown or disposed within another processor that combines some of the functions described above for FIG. 6b. Any or all of these various processors of FIG. 6b access one or more of the various memories, which may be on-chip with the processor or separate therefrom. Similar function-specific components that are directed toward communications over a network broader than a piconet (e.g., components 36, 38, 40, 42-45 and 47) may also be disposed in exemplary embodiments of the access node 12, which may have an array of tower-mounted antennas rather than the two shown at FIG. 6b. The invention may be embodied in such similar processors at the eNB 12 also or alternatively. For the case of the FIR moving window implementation, the FIR filter may be disposed also in the baseband processor 42, but the filter itself need not be a part of the embodied invention as claimed, for example the embodied invention may simply control the filter as described in the exemplary embodiment detailed above.

Note that the various chips (e.g., 38, 40, 42, etc.) that were described above may be combined into a fewer number than described and, in a most compact case, may all be embodied physically within a single chip.

The various blocks shown in FIG. 3 as well as the specific memory data transforms shown at FIGS. 4a-e and 5a-b may be viewed as method steps, and/or as operations that result from operation of computer program code, and/or for the case of FIG. 3 as a plurality of coupled logic circuit elements constructed to carry out the associated function(s).

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as nonlimiting examples, hardware, software, firmware, special purpose circuits or logic, general purpose hardware or controller or other computing devices, or some combination thereof.

It should thus be appreciated that at least some aspects of the exemplary embodiments of the inventions may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

It should be appreciated that the exemplary embodiments of this invention are not limited for use with any one particular wireless protocol (e.g., LTE) or even to communications in general (e.g., can be employed for image processing apart from communicating the image data), but may be used to advantage in other wireless communication systems such as for example WLAN, UTRAN, global system for mobile communications GSM, wideband code division multiple access WCDMA, and the like.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements maybe considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

1. A method comprising:
storing subvector slices x(i,r,s) of a first vector x(i) in a bit-parallel word-serial manner;
for each of the stored subvector slices and in parallel on bits of said each subvector slice, executing an operation that outputs a pre-calculated inner product result of the said bits and a second vector a; and
outputting a result that depends from the executed operation.

2. The method of claim 1, wherein the method is executed on a plurality of first input vectors x(i) in parallel.

3. The method of claim 1, wherein storing the subvector slices in the bit-parallel word-serial manner comprises:
storing subvector slices x(i,r,s) of the first vector x(i) in a bit-serial word-serial manner; and
transforming the subvector slices which are stored in the bit-serial word-serial manner to be stored in the bit-parallel word-serial manner.

4. The method of claim 3, wherein transforming the stored subvector slices comprises:
copying relevant bits of each of the subvector slices from a 0^{th} column of a content-addressable memory array to elements of a tags register; and, for each k^{th} iteration:
shifting bits in the elements of the tags register by m positions; and copying the shifted bits to a column of the content addressable memory array.

5. The memory of claim 4, wherein copying the shifted bits comprises, for each k^{th} iteration, copying the shifted bits to a (k+1)^{st} column of the content addressable memory array adjacent to the k^{th} column.

6. The method of claim 1, wherein the operation is a compare and write operation and the pre-calculated inner product result is an inner product between the subvector slice x(i,r,s) of the first vector x(i) and the second vector a, wherein the subvector slice x(i,r,s) is a binary subvector slice.

7. The method of claim 6, wherein outputting the result that depends from the executed operation comprises outputting a summation of the pre-calculated inner product result across all of the subvector slices x(i,r,s) of the first input vector x(i).

8. The method of claim 1, wherein the operation that outputs a pre-calculated inner product result is executed by an associative processor and in a distributed arithmetic manner across the subvector slices which are stored in the bit-parallel word-serial manner.

9. The method of claim 1, wherein the operation that outputs a pre-calculated inner product result excludes a multiplication operation.

10. A computer readable memory storing a program of instructions executable by a processor to take actions comprising:
storing subvector slices x(i,r,s) of a first vector x(i) in a bit-parallel word-serial manner;
for each of the stored subvector slices and in parallel on bits of said each subvector slice, executing an operation that outputs a pre-calculated inner product result of the said bits and a second vector a; and
outputting a result that depends from the executed operation.

11. The computer readable memory of claim 10, wherein storing the subvector slices in the bit-parallel word-serial manner comprises:
storing subvector slices x(i,r,s) of the first vector x(i) in a bit-serial word-serial manner; and
transforming the subvector slices which are stored in the bit-serial word-serial manner to be stored in the bit-parallel word-serial manner

12. The computer readable memory of claim 10, wherein transforming the stored subvector slices comprises:
copying relevant bits of each of the subvector slices from a 0^{th} column of a content-addressable memory array to elements of a tags register; and, for each k^{th} iteration:
shifting bits in the elements of the tags register by m positions; and
copying the shifted bits to a column of the content addressable memory array.

13. The computer readable memory of claim 10, wherein the operation is a compare and write operation and the pre-calculated inner product result is an inner product between the subvector slice x(i,r,s) of the first vector x(i) and the second vector a, wherein the subvector slice x(i,r,s) is a binary subvector slice.

14. The computer readable memory of claim 10, wherein the operation that outputs a pre-calculated inner product result is executed by an associative processor and in a distributed arithmetic manner across the subvector slices which are stored in the bit-parallel word-serial manner.

15. The computer readable memory of claim 10, wherein the operation that outputs a pre-calculated inner product result excludes a multiplication operation.

16. An apparatus comprising:
a data storage array in which subvector slices x(i,r,s) of a first vector x(i) are stored in a bit-parallel word-serial manner; and
a processor configured to execute an operation, on each of the stored subvector slices and in parallel on bits of said each subvector slice, that outputs a pre-calculated inner product result of the said bits and a second vector a.

17. The apparatus of claim 16, wherein the processor is configured to execute the operation on a plurality of first input vectors x(i) in parallel.

18. The apparatus of claim 15, wherein the data storage array and the processor are configured to transform the subvector slices x(i,r,s) of the first vector x(i) from a bit-serial word-serial manner in which they are initially stored in the array, to be stored in the bit-parallel word-serial manner in the array.

19. The apparatus of claim 18, wherein the processor and the array are configured to transform the stored subvector slices by:
copying relevant bits of each of the subvector slices from a 0^{th} column of a content-addressable memory array to elements of a tags register; and, for each k^{th} iteration:
shifting bits in the elements of the tags register by m positions; and
copying the shifted bits to a column of the content addressable memory array.

20. The apparatus of claim 19, wherein the processor is configured to copy the shifted bits by, for each kth iteration, copying the shifted bits to a (k+1)^{st} column of the content addressable memory array adjacent to the k^{th} column.

21. The apparatus of claim 15, wherein the operation is a compare and write operation and the pre-calculated inner product result is an inner product between the subvector slice x(i,r,s) of the first vector x(i) and the second vector a, wherein the subvector slice x(i,r,s) is a binary subvector slice.

22. The apparatus of claim 21, wherein the processor is further configured to sum the pre-calculated inner product result across all of the subvector slices x(i,r,s) of the first input vector x(i).

23. The apparatus of claim 15, wherein the processor comprises an associative processor which operates in a distributed arithmetic manner across the subvector slices which are stored in the bit-parallel word-serial manner.

24. The apparatus of claim 15, wherein the operation that outputs a pre-calculated inner product result excludes a multiplication operation.

25. An apparatus comprising:
storage means for storing subvector slices x(i,r,s) of a first vector x(i) in a bit-parallel word-serial manner; and
processing means for executing an operation, on each of the stored subvector slices and in parallel on bits of said each subvector slice, that outputs a pre-calculated inner product result of the said bits and a second vector a.

26. The apparatus of claim 25, wherein the storage means and the processing means are for transforming the subvector slices x(i,r,s) of the first vector x(i) from a bit-serial word-serial manner in which they are initially stored in the storage means, to be stored in the bit-parallel word-serial manner in the storage means.

27. The apparatus of claim 26, wherein the processing means and the storage means are for transforming the stored subvector slices by:
copying relevant bits of each of the subvector slices from a 0^{th} column of a content-addressable memory array to elements of a tags register; and, for each k^{th} iteration:
shifting bits in the elements of the tags register by m positions; and
copying the shifted bits to a column of the content addressable memory array.

28. The apparatus of claim 25, wherein the operation is a compare and write operation and the pre-calculated inner product result is an inner product between the subvector slice x(i,r,s) of the first vector x(i) and the second vector a, wherein the subvector slice x(i,r,s) is a binary subvector slice.

29. The apparatus of claim 28, wherein the processing means is further configured to sum the pre-calculated inner product result across all of the subvector slices x(i,r,s) of the first input vector x(i).

30. The apparatus of claim 25, wherein the storage means comprises a content addressable memory storage array, and the processing means comprises an associative processor which operates in a distributed arithmetic manner across the subvector slices which are stored in the bit-parallel word-serial manner.

31. The apparatus of claim 25, wherein the operation that outputs the pre-calculated inner product result excludes a multiplication operation.
